(19) United States
(12) Patent Application Publication
(10) Pub. No.: US 2008/0002899 A1
(43) Pub. Date: Jan. 3, 2008

(54) Dynamic Compression Method for Use in Compressing Image Data

(76) Inventors: Curt Paul Breswick, Georgetown, KY (US); Khageshwar Thakur, Lexington, KY (US); Keith Allen Wahnsiedler, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/427,874

(22) Filed: Jun. 30, 2006

(51) Int. Cl. G06K 9/36

(52) U.S. Cl. 382/244

(57) ABSTRACT

A method for dynamically compressing image data to fit within a predefined memory capacity of a memory buffer includes dividing the image data into a plurality of data bands; determining an average band memory size in the memory buffer for each data band of the plurality of data bands; compressing a current data band at a compression quality level; and adjusting the compression quality level for a next data band of the plurality of bans to be compressed based on the average band memory size and a compressed memory size of the current data band.

### FIELD OF THE INVENTION

The present invention relates to processing image data, and, more particularly, to a method for dynamically compressing image data to fit within a predefined memory capacity of a memory buffer.

### BACKGROUND OF THE INVENTION

Consumer electronic devices, such as printers, All-In-One (AIO) devices (e.g., a unitary printer/scanner/copiers), or digital cameras transfer digital images within a system. One way to transfer digital images in an efficient manner is to apply a lossy compression to the digital image. Note only does this reduce the amount of memory needed to store the image, but it also decreases the bandwidth needed as the image is processed.

A lossy compression, such as JPEG, performed on an image will result in a great data compression, but with some image quality degradation, that may or may not be noticeable to a user. Both the amount of image quality loss and data compression ratio are controlled by a single “quality factor” setting with a range from 100 to 1. A quality factor setting of 100 will result in the greatest image quality and the smallest data compression ratio, and in turn result in the largest file size. A quality factor setting of 1 will result in the greatest data compression ratio, and in turn the smallest file size, with the poorest image quality.

When performing a photo copy with one such AIO, a lossy compression is applied to the image data as it is scanned in order to keep the scan motor running smoothly as the image is processed before being printed. The data is stored in a memory buffer that is limited in size, depending on the amount of available memory in a given computer system.

Scan targets, e.g., an original document, usually consist of text, graphics, photographs, or a mixture of all three. Text and graphics in most cases can be characterized as high-frequency data (text, borders) surrounded by low-frequency data (smooth single colors). Text portions usually compress very well yielding good image quality and a small file size, even at a high quality factor. This is because the low-frequency portions of the image compress very well to small sizes with little effect on image quality. Photographs can be characterized as medium to high-frequency data with many variations in the image. The photograph portions of an image usually compress well to a small file size, with little noticeable defects to the image, even at a lower quality factor setting.

In the past, a single global quality setting has been used as the image is compressed. In particular, a quality factor had to be chosen such that all of the scanned images would fit within the limits of the available image memory buffer without failure. For example, in some products where memory was limited, it was necessary for a lower quality factor to be chosen, which typically resulted in noticeable print quality defects, particularly when processing high-frequency image data.

### SUMMARY OF THE INVENTION

The present invention provides a method to dynamically adjust the image quality level, i.e., the amount of data loss, as an image is being compressed, thereby permitting all, or substantially all, of the available memory to be used, if desired.

The invention, in one form thereof, is directed to a method for dynamically compressing image data to fit within a predefined memory capacity of a memory buffer. The method includes dividing the image data into a plurality of data bands; determining an average band memory size in the memory buffer for each data band of the plurality of data bands; compressing a current data band at a compression quality level; and adjusting the compression quality level for a next data band of the plurality of bands to be compressed based on the average band memory size and a compressed memory size of the current data band.

The invention, in another form thereof, is directed to an apparatus for processing image data. The apparatus includes a memory buffer having a predefined memory capacity. A controller is communicatively coupled to the memory buffer. The controller executed program instructions to perform the operations of dividing the image data into a plurality of data bands; determining an average band memory size in the memory buffer for each data band of the plurality of data band; compressing a current data band at a compression quality level; and adjusting the compression quality level for a next data band of the plurality of bands to be compressed based on the average band memory size and a compressed memory size of the current data band.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG 1. is a diagrammatic depiction of an imaging system embodying the present invention.

FIG. 2 is a flowchart of a method of dynamically compressing image data to fit within a predefined memory capacity of a memory buffer.

FIG. 3 shows a graph plotting band number versus memory capacity, with the graph overlaying an image target.

FIG. 4 shows a graph plotting band number versus compression quality level, with the graph overlaying the image target.

FIG. 5 shows a graph plotting band number versus compression quality level, with the graph overlaying the image target.

Corresponding reference characters indicate corresponding parts throughout the several views. The exemplifications set out herein illustrate exemplar embodiments of the invention, and such exemplifications are not to be construed as limiting the scope of the invention in any manner.

### DESCRIPTION OF THE PREFERRED EMBODIMENT

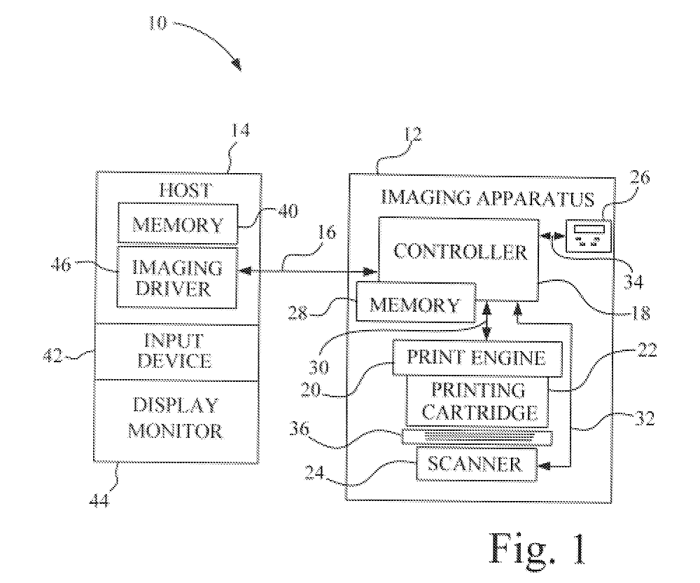

Referring now to the drawings and particularly to FIG. 1, there is shown a diagrammatic depiction of an imaging system 10 embodying the present invention. Imaging system 10 may include an imaging apparatus 12 and a host 14. Imaging apparatus 12 communicates with host 14, when present, via a communications link 16. As used herein, the term “communications link” is used to generally refer to structure that facilitates electronic communications between multiple components, and may operate using wired or wireless technology.

Imaging apparatus 12 may be, for example, an ink jet printer and/or copier, an electrophotographic printer and/or copier, a thermal transfer printer and/or copier, or an all-in-one (AIO) unit that includes a print engine, a scanner unit, and possibly a fax unit that incorporate multiple functions such as scanning, copying, and printing capabilities in one device. An AIO unit is also known in the art as a multifunction machine. For example, as shown in FIG. 1, imaging apparatus 12 includes a controller 18, a print engine 20, a printing cartridge 22, a scanner unit 24, and a user interface 26. Print engine 20 may utilize ink jet, dot matrix, dye sublimation, laser, and any other suitable print formats. Imaging apparatus 12 may communicate with host 14 via a standard communication protocol, such as for example, universal serial bus (USB), Ethernet or IEEE 812.1x.

Controller 18 includes a processor unit and associated memory buffer 28, and may be formed as one or more Application Specific Integrated Circuits (ASIC). Memory buffer 28 is communicatively coupled to controller 18, and may be, or example, random access memory (RAM), and/or non-volatile RAM (NVRAM). Alternatively, memory buffer 28 may be in the form of a separate electronic memory that is communicatively coupled to controller 18. Controller 18 may be a printer controller, a scanner controller, or may be a combined printer and scanner controller. In the present embodiment, controller 18 communicates with print engine 20 via a communication link 30. Controller 18 communicates with scanner unit 24 via a communication link 32. User interface 26 is communicatively coupled to controller 18 via a communication link 34. Controller 18 serves to process print data and to operate print engine 20 during printing, as well as to operate scanner unit 24 and process image data obtained via scanner unit 24.

In the context of the examples for imaging apparatus 12 given above, print engine 20 may be, for example, an ink jet print engine, an electrophotographic print engine or a thermal transfer engine, configured for forming an image on a sheet of print media 36, such as a sheet of pater transparency of fabric. As an ink jet print engine, for example, print engine 20 operates printing cartridge 22 to eject ink droplets onto the sheet of print media 36 in order to reproduce text and/or images. As an electrophotographic print engine, for example, print engine 20 causes printing cartridge 22 to deposit toner onto the sheet of print media 36, which is then fused to the sheet of print media 36 be a fuser (not shown), in order to reproduce text and/or images.

Host 14, which may be optional, may be, for example, a person computer including memory 40, such as RAM, ROM, and/or NVRAM, an input device 42, such as a keyboard, and a display monitor 44. Host 14 further includes a processor, input/output (I/O) interfaces, and at least one mass data storage device, such as a hard drive, a CD-ROM and/or a DVD unit.

Host 14 includes in its memory a software program including program instructions that function as an imaging driver 46, e.g., printer/scanner driver software, for imaging apparatus 12. Imaging driver 46 is in communication with controller 18 of imaging apparatus 12 via communications link 16. Imaging drive 46 facilitates communication between imaging apparatus 12 and host 14, and may provide formatted print data to imaging apparatus 12, and more particularly, to print engine 20, to print an image.

In some circumstances, it may be desirable to operate imaging apparatus 12 in a standalone mode. In the standalone mode, imaging apparatus 12 is capable of functioning without host 14. Accordingly, all or a portion of imaging driver 46, or a similar driver, may be located in controller 18 of imaging apparatus 12 so as to accommodate printing during a copying or facsimile job being handled by imaging apparatus 12 when operating in the standalone mode.

Scanner unit 24 may be of a conventional scanner type, such as for example, a sheet feed or flat bed scanner, for scanning a document. In the context of the present invention, either scanner type may be used. As is known in the art, a sheet feed scanner transports a document to the scanned past a stationary sensor device, e.g., a stationary scan bar, and a flat bed scanner scans a stationary document with a movable scan bar.

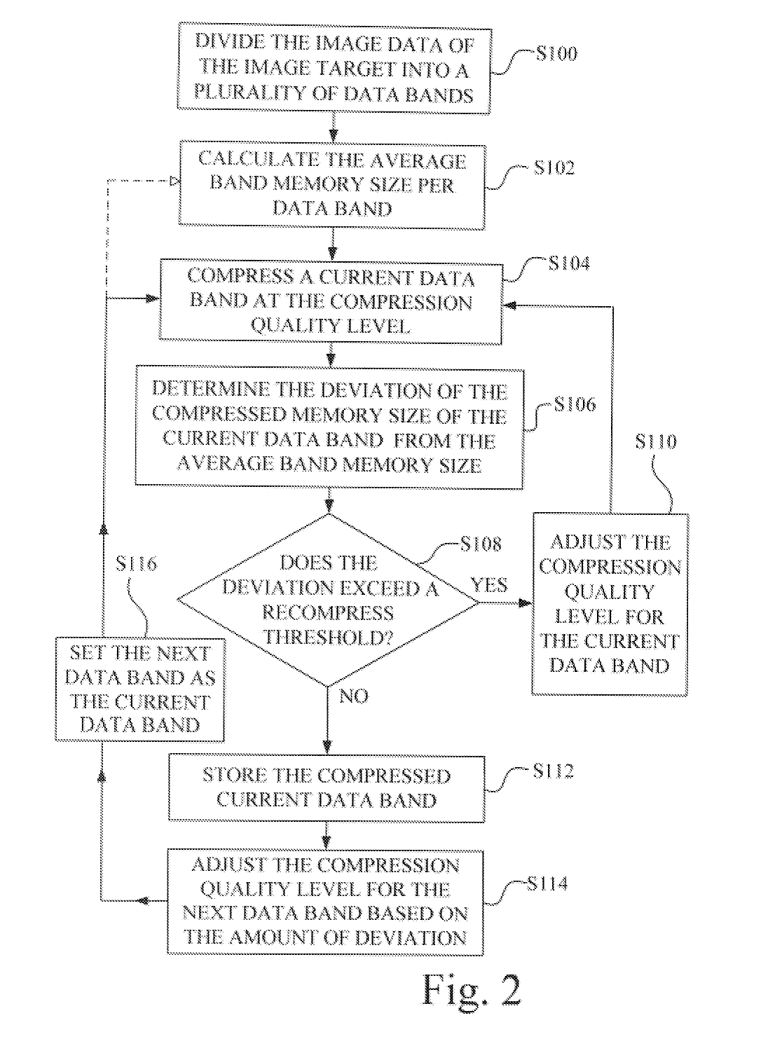

FIG. 2 is a flowchart of a method for dynamically compressing image data to fit within a predefined memory capacity of a memory buffer, such as for example, memory buffer 28 of imaging apparatus 12 or a portion of memory 40 of host 14. The method may be implemented as a set of program instructions. The program instructions may be executed, for example, by controller 18 of imaging apparatus 12, or by a controller of host 14. In summary, the compression quality level is dynamically adjusted as an image is compressed such that all, or substantially all, of the available memory in the memory buffer is used. The present method ensured that worts-case images will be compressed successfully, while allowing a greater quality for most images, since the available memory is used in an efficient manner.

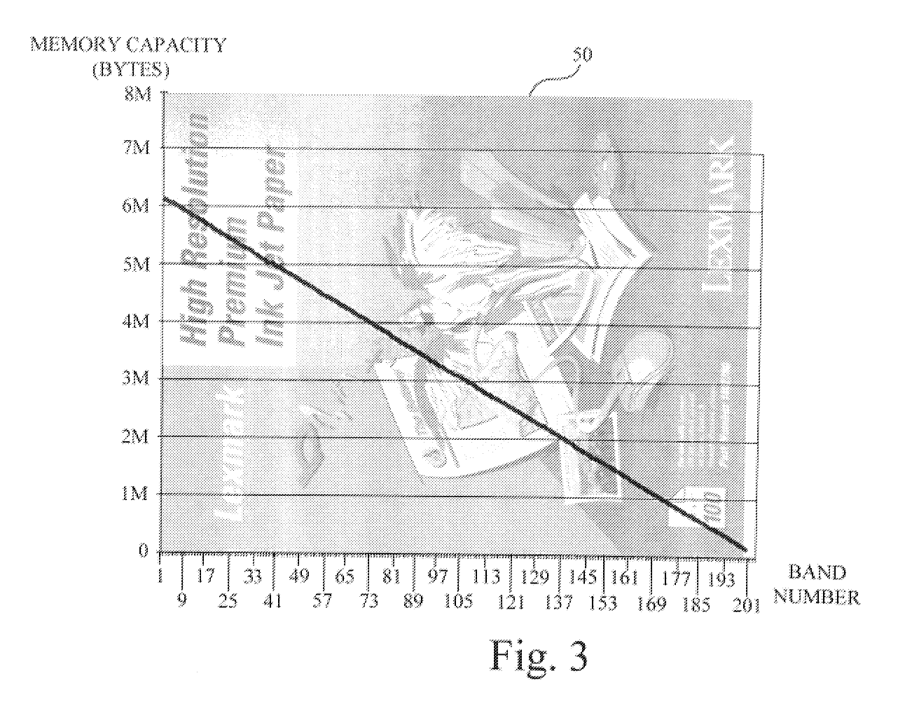

at step S100, the image data of an image target is divided into a plurality of bands. The image target may be, for example, a scanned document that was scanned by scanner unit 24, or may be the output of an application running on host 14. FIG. 3 shows a graph plotting band number versus memory capacity, with the graph overlaying an image target 50. In the example of FIG. 3, image target 50 is divided into a plurality of bands, e.g., 201 bands in this example, which may be individually identified as BAND 1 through BAND 201 along the horizontal axis plotted against a memory capacity (in bytes) of a memory buffer, such as memory buffer 28.

As an example, before image target 50 is even scanned, the dimensions of image target 50 are already known in terms of pixels. Both the vertical resolution of the image and number of lines in a band can be used to determine the number of bans needed to process the entire page. One exemplary algorithm for calculating the number of data bands is given as:

$$Number Of Bands On Page = \frac{\begin{matrix}( Input Pixel Size Y + \\ Number Of Lines Per Band - 1 )\end{matrix}}{Number Of Lines Per Band}$$

wherein Input Pixel Size Y is the number of pixels in a direction perpendicular to the extent of a line, e.g., the page height in pixels.

At step S102, the average band memory size in the memory buffer, e.g., memory buffer 28, for each data band is calculated, based upon the memory capacity of the memory, e.g., memory buffer 28, to be used in storing the compressed image data and the number of data bands, e.g., 201 bands in the example of FIG. 3. As illustrated in FIG. 3, the size of image target 50 is approximately 8.0 megabytes, and the memory capacity of memory buffer 28 is about 6.1 megabytes for storing the compressed image data for image target 50.

The following is an exemplary algorithm for calculating average band memory size

Average Bytes Per Band=Memory Buffer Size/Number Of Bands On Page.

At step S104, the current band is compressed at a compression quality level. For example, if the current band is BAND 1, as the first band to undergo compression the compression quality level is a predetermined level, such as an initial compression quality level of 90 on a scale from 1 to 100. As used herein, the term “current band” refers to the particular date band of the plurality of data bands that is being subject to compression. In the present embodiment, for example, only one data band will be subject to compression at a time, and that data band will be designated as the “current data band”. As explained in more detail below, the compression quality level will undergo dynamic adjustment for subsequent data bands.

At step S106, the process determines the deviation of the compressed memory size of the current data band from the average band memory size, determined in step S102. The following is an exemplary algorithm for calculating the deviation:

Deviation From Average=Abs. Val. (CMS−ABPB)/(ABPB)×100 percent

wherein: Abs. Val. is an absolute value operation;
CMS is the compressed memory size of the current data band; and
ABPS is the Average Bytes Per Band.

In the exemplary equation above for calculating deviation, the result is a value in percent. Those skilled in the art will recognize that the deviation may be calculated in other ways, such as way of a simple subtraction operation, and may be in forms other than a percentage.

At step S108, it is determined whether the deviation calculated in step S106 exceeds a recompress threshold. The recompress threshold may be, for example, a tolerance range. For example, the tolerance range may be based on the average data band memory size, or on a particular operating configuration of the imaging apparatus, such as imaging apparatus 12. Also, for example, the tolerance range may be determined empirically, arbitrarily chosen, or calculated based on predetermined factors of concern.

If the result of the determination at step S108 is YES, then the amount of deviation is determined to be outside acceptable limits of the recompress threshold, and the process proceeds to step S110. For example, if the deviation exceeds the limits of a tolerance range that is based on the average band memory size, the current compression quality level is not appropriate for the target content. Thus, the compression quality level will be adjusted accordingly and the current data band will be compressed again.

At step S110, the compression quality level for the current data band is adjusted to compensate for the amount of deviation determined at step S106. The process returns to step S104, where the current band is recompressed at the adjusted compression quality level. In cases where the compressed memory size of the current data band was too large, recompression ensures that the deviation from the average is kept within a certain tolerance. In cases where the compressed memory size of the current data band was too small, recompression ensured that compression artifacts to the image are kept to a minimum.

Table 1, below, illustrates how the compression quality level may be adjusted based on the amount of deviation.

TABLE 1
Compression Quality Level Adjustment Based on Deviation
From Average Band Memory Size

| Deviation From Average Band | |
|---|---|
| Memory Size (DFA) | Compression Quality Level |
| (in percent) | Adjustment Step Size |
| DFA > 100 | 5 |
| 100 ≧ DFA > 75 | 4 |
| 75 ≧ DFA > 50 | 3 |
| 50 ≧ DFA > 25 | 2 |
| 25 ≧ DFA > 6 | 1 |
| 6 ≧ DFA | 0 |

In the present embodiment, the process will remain in the loop of steps S104, S106, S108 and S110 until the determination of step S108 is NO. However, those skilled in the art will recognize that the number of loops may be limited as a practical matter, either through the selection of the adjusted compression quality level, or through the use of a limit placed on the number of times the loop will be executed.

If the determination at step S108 is NO, then the process proceeds to step S112.

At step S112, the compressed current date band is stored in memory buffer 28.

At step S114, the compression quality level for the next data band is adjusted to compensate for the amount of deviation determined at step S106. For example, the compression quality level is decreased or increased as needed based on how well the target data compresses. Sometimes the image data compressed well and the compression quality level can be increased, other times image data does not compress will and the compression quality level is decreased to ensure that the entire page fits into the compressed buffer space of the memory buffer, e.g., memory buffer 28. Also, the average memory per band can be maintained by adjusting the compression quality level of the next data band based on the deviation of the compressed memory size of the current data band from the average band memory size. Sometimes a less-than-average amount of memory is used, sometimes more.

At step S116, the next data band, e.g., BAND 2, etc., is set as the new current data band, and the process returns to step S104, where the new current band is compressed at the current compression quality level.

Steps S104 through S116 are repeated, as necessary, until the last data band, e.g., BAND 201 in the example of FIG. 3, is compressed.

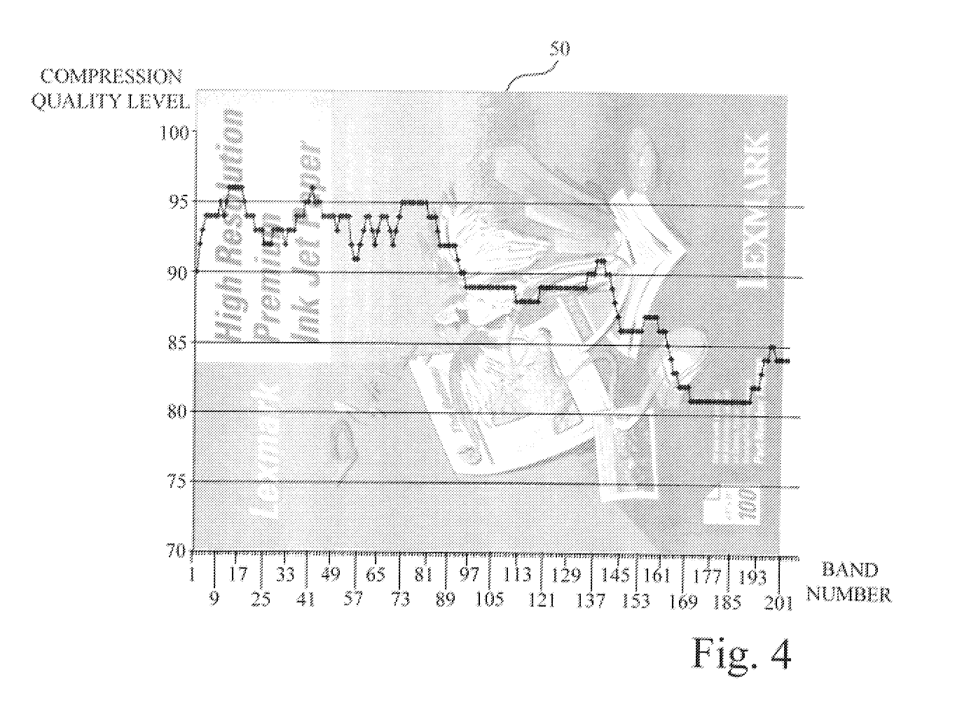

As illustrated in FIG. 3, image target 50 compressed using the method of FIG. 2 results in a generally linear reduction in the amount of memory used from memory buffer 28 from full capacity of 6.1 Mbytes at BAND 1 to nearly 0.0 bytes remaining after compressing BAND 201, even though there may be significant changes in the compression quality level throughout the compression of image target 50 from BAND 1 through BAND 201, as illustrated in FIG. 4.

FIG. 4 shows a graph plotting band number versus compression quality level, with the graph overlaying image target 50. As shown, during the compression of image target 50 from BAND 1 through BAND 201, the compression quality level is adjusted in the range of about 81 to about 97, with an initial compression quality level of 90, while as shown in the graph of FIG. 3, substantially all of the available memory capacity of memory buffer 28 is used for storing the compressed data.

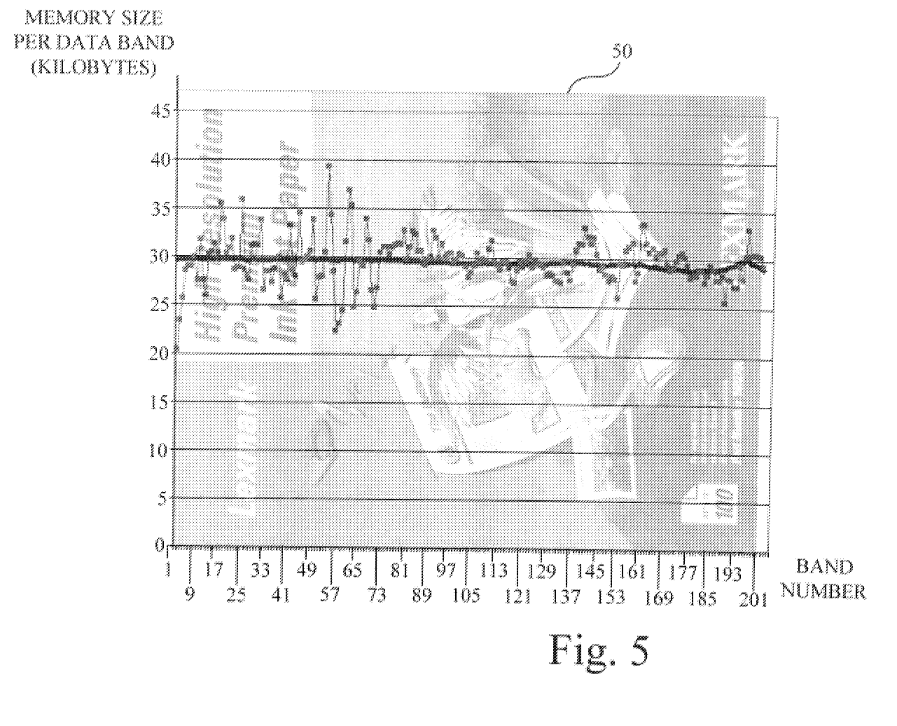

FIG. 5 shows a graph plotting band number versus memory size per data band, with the graph overlaying image target 50. As illustrated in FIG. 5, the amount of memory used per band is not constant, but rather, varies around an average of about 30 kilobytes per data band. This variation is due to the change in the compression quality level, wherein a decrease in compression quality level will tend to free up more memory available to be used per band.

In order to take full advantage of variations in memory usage per data band, one variation of the method depicted in FIG. 3 is to repeat step S102 for each data band, wherein the average band memory size per data band would be recalculated for each data band based on the number of data bands remaining and the amount of remaining memory capacity in memory buffer 28, so as to maintain a rolling average. In this variation, step S116 would lead to step S102, rather than S104, as depicted by the dashed line.

While this invention has been described with respect to embodiments of the invention, the present inventions may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method for dynamically compressing image data to fit within a predefined memory capacity of a memory buffer, comprising:
dividing said image data into a plurality of data bands;
determining an average band memory size in said memory buffer for each data band of said plurality of data bands;
compressing a current data band at a compression quality level; and
adjusting said compressions quality level for a next data band of said plurality of bands to be compressed based on said average band memory size and a compressed memory size of said current data band.

2. The method of claim 1, further comprising:
setting said next data band as said current data band to be compressed; and
repeating the acts of compressing and adjusting until all of said plurality of data bands have been compressed.

3. The method of claim 1, wherein said adjusting includes the acts of:
determining an amount of deviation of said compressed memory size of said current data band from said average band memory size; and
adjusting said compression quality level for said next data band of said plurality of bands to be compressed based on said amount of deviation.

4. The method of claim 1, further comprising:
determining an amount of deviation of said compressed memory size of said current data band from said average band memory size;
determining whether said amount of deviation is within an acceptable tolerance range, wherein if said amount of deviation is outside said acceptable tolerance range, then said method including the further acts of:
adjusting said compression quality level for said current data band based on said amount of deviation; and
recompressing said current data band based on the adjusted compression quality level for said current data band.

5. The method of claim 4, further comprising:
determining a revised amount of deviation of the recompressed memory size of said current data band from said average band memory size; and
adjusting said compression quality level for said next data band of said plurality of bands to be compressed based on said revised amount of deviation.

6. The method of claim 1, wherein said average band memory size is calculated anew for each data band of said plurality of data bands.

7. An apparatus for processing image data, comprising:
a memory buffer having a predefined memory capacity; and
a controller communicatively coupled to said memory buffer, said controller executing program instructions to perform the operations of:
dividing said image data into a plurality of data bands;
determining an average band memory size in said memory buffer for each data band of said plurality of data bands;
compressing a current data band at a compression quality level; and
adjusting said compression quality level for a next data band of said plurality of bans to be compressed based on said average band memory size and a compressed memory size of said current data band.

8. The apparatus of claim 7, said controller executing program instructions to perform the operations of:
setting said next date band as said current data band to be compressed; and
repeating the operations of compressing and adjusting until all of said plurality of data bands have been compressed.

9. The apparatus of claim 7, said controller executing program instructions to perform the operations of:
determining an amount of deviation of said compressed memory size of said current data band from said average band memory size; and
adjusting said compression quality level for said next data band of said plurality or bands to be compressed based on said amount of deviation.

10. The apparatus of claim 7, said controller executing program instructions to perform the operations of:
determining an amount of deviation of said compressed memory size of said current data band from said average band memory size;
determining whether said amount of deviation is within an acceptable tolerance range, wherein if said amount of deviation is outside said acceptable tolerance range, then said method including the further operations of:
adjusting said compression quality level for said current data band based on said amount of deviation; and
recompressing said current data band based on the adjusted compression quality level for said current data band.

11. The apparatus of claim 10, said controller executing program instructions to perform the operations of:
determining a revised amount of deviation of the recompressed memory size of said current data band from said average band memory size; and
adjusting said compression quality level for said next data band of said plurality of bands to be compressed based on said revised amount of deviation.

12. The method of claim 7, wherein said average band memory size is calculated anew for each data band of said plurality of data bands.
